(19) United States
(12) Patent Application Publication
(10) Pub. No.: US 2022/0223854 A1
(43) Pub. Date: Jul. 14, 2022

(54) NEGATIVE ELECTRODE MATERIAL AND ELECTROCHEMICAL APPARATUS AND ELECTRONIC APPARATUS CONTAINING SAME

(71) Applicant: Ningde Amperex Technology Limited, Ningde (CN)

(72) Inventors: Daoyi JIANG, Ningde (CN); Zhihuan CHEN, Ningde (CN); Ting ZHANG, Ningde (CN); Hang CUI, Ningde (CN)

(73) Assignee: Ningde Amperex Technology Limited, Ningde (CN)

(21) Appl. No.: 17/708,501

(22) Filed: Mar. 30, 2022

Related U.S. Application Data
(63) Continuation of application No. PCT/CN2019/128835, filed on Dec. 26, 2019.

(51) Int. Cl. H01M 4/38; H01M 4/62; H01M 4/134

(52) U.S. Cl. CPC H01M 4/386; H01M 4/623; H01M 2004/027; H01M 4/134; H01M 4/625

(57) ABSTRACT

A negative electrode material includes silicon-based particles. The silicon-based particles include a silicon-containing matrix and a polymer layer disposed on at least a portion of a surface of the silicon-containing matrix, and the polymer layer includes a carbon material and a polymer; when a thermogravimetric analysis is conducted at a temperature ranging from 0° C. to 800° C., a derivative thermogravimetric curve of the polymer in a free state has at least one characteristic peak, a temperature at the maximum characteristic peak of the at least one characteristic peak is Ti, a derivative thermogravimetric curve of the silicon-based particles has at least one characteristic peak, a temperature at the maximum characteristic peak of the at least one characteristic peak is T₂, and T₁-T₂ is from 1.5° C. to 20° C. A lithium-ion battery prepared from the negative active material has improved cycle performance and deformation resistance, and reduced DC resistance.

### CROSS-REFERENCE TO RELATED APPLICATIONS

This application is a bypass continuation application of PCT application PCT/CN2019/128835, filed on Dec. 26, 2019, the disclosure of which is hereby incorporated by reference in its entirety.

### TECHNICAL FIELD

This application relates to the field of energy storage, and in particular, to a negative electrode material and an electrochemical apparatus and an electronic apparatus containing the same, especially a lithium-ion battery.

### BACKGROUND

With popularization of consumer electronics products such as notebook computers, mobile phones, tablet computers, mobile power sources, and unmanned aerial vehicles, requirements on electrochemical apparatus therein are becoming stricter. For example, not only does the battery have to be portable, but also it needs to have a high capacity and a relatively long service life. Lithium-ion batteries have occupied the mainstream position in the market by virtue of their outstanding advantages such as high energy density, high safety, no memory effect and long service life.

### SUMMARY

The embodiments of this application provide a negative electrode material in an attempt to at least to some extent address issues of low cycle performance, poor deformation resistance, and/or high DC resistance of lithium-ion batteries in the prior art. The embodiments of this application further provide a negative electrode, an electrochemical apparatus, and an electronic apparatus that use the negative electrode material.

In one embodiment, this application provides a negative electrode material including silicon-based particles, where the silicon-based particles include a silicon-containing matrix and a polymer layer disposed on at least a portion of a surface of the silicon-containing matrix, and the polymer layer includes a carbon material and a polymer; when a thermogravimetric analysis is conducted at a temperature ranging from 0° C. to 800° C.: a derivative thermogravimetric curve of the polymer in a free state has at least one characteristic peak, a temperature at the maximum characteristic peak of the at least one characteristic peak is T₁, a derivative thermogravimetric curve of the silicon-based particles has at least one characteristic peak, a temperature at the maximum characteristic peak of the at least one characteristic peak is T₂, and T₁-T₂ is from 1.5° C. to 20° C.

In another embodiment, this application provides a negative electrode including the negative electrode material according to the embodiments of this application.

In another embodiment, this application provides an electrochemical apparatus including the negative electrode according to the embodiments of this application.

In another embodiment, this application provides an electronic apparatus including the electrochemical apparatus according to the embodiments of this application.

Coating the surface of the silicon-containing matrix is a commonly used technique for improving cycle stability of the silicon-containing matrix. Currently available coating materials mainly include metals, polymers, oxides, and carbon. Carbon coating can significantly improve conductivity of the silicon-based particles while improving volume expansion of the silicon-based particles, which is a technique that has been widely used in recent years. Carbon-coated materials in the prior art are likely to be peeled off due to a force generated by expansion of the silicon-containing matrix in a battery cycle process, resulting in significantly poor cycle performance Therefore, it is necessary to choose a suitable method to fix the conductive carbon material on the surface of the silicon-containing matrix.

In this application, by coating the surface of the silicon-containing matrix with a composite layer of a carbon material and a polymer, the overall conductivity of the silicon-based particles can be improved. In this case, selection of polymer materials that interact with a surface active group of the silicon-containing matrix can address a peeling issue of carbon materials in cycling and significantly improve the surface stability of the silicon-based particles, thereby significantly improving their cycle performance.

The inventor of this application found that there is a weak interaction between the polymer layer and the silicon-containing matrix at an interface, which is more conducive to uniformly coat the polymer layer on the surface of the silicon-containing matrix. As the polymer layer is uniformly coated on the surface of the silicon-containing matrix, when a thermogravimetric analysis is conducted at a temperature ranging from 0° C. to 800° C., the temperature T₁ at the maximum characteristic peak of the derivative thermogravimetric curve of the polymer in the free state is higher than the temperature T₂ at the maximum characteristic peak of the derivative thermogravimetric curve of the silicon-based particles obtained after the polymer is coated. When the polymer layer is not uniformly distributed on the surface of the silicon-containing matrix, T₁ and T₂ are basically close, and the obtained silicon-based particles with the polymer layer have a poorer cycle effect.

The inventor of this application further found that when T₁-T₂ is in a range of 1.5° C. to 20° C., cycle performance and deformation resistance of the lithium-ion battery prepared from the negative active material of this application are improved, and direct current resistance of the lithium-ion battery is reduced.

Additional aspects and advantages of the embodiments of this application are partially described and presented in the later description, or explained by implementation of the embodiments of this application.

### BRIEF DESCRIPTION OF DRAWINGS

The accompanying drawings necessary for describing the embodiments of this application or the prior art will be briefly described below in order to describe the embodiments of this application. Obviously, the accompanying drawings in the following description are only some embodiments of this application. It will be apparent to those skilled in the art that drawings of other embodiments can still be obtained from the structures illustrated in these accompanying drawings without creative effort.

FIG. 1 is a schematic structural diagram of a negative active material according to an Example of this application;

FIG. 2 shows a thermogravimetric curve and a derivative thermogravimetric curve of the polymer in a free state in Example 2 of this application;

FIG. 3 shows a thermogravimetric curve and a derivative thermogravimetric curve of the silicon-based negative active material in Example 2 of this application; and

FIG. 4 is a scanning electron microscope (SEM) diagram of the silicon-based negative active material in Example 2 of this application.

### DETAILED DESCRIPTION

Embodiments of this application will be described in detail below. The embodiments of this application shall not be construed as a limitation on this application.

The term “approximately” used herein are intended to describe and represent small variations. When used in combination with an event or a circumstance, the term may refer to an example in which the exact event or circumstance occurs or an example in which an extremely similar event or circumstance occurs. For example, when used in combination with a value, the term may refer to a variation range of less than or equal to ±10% of the value, for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

In this application, a derivative thermogravimetric curve (derivative thermogravimetry, DTG) refers to the first derivative of the thermogravimetric curve with respect to time or temperature.

In addition, quantities, ratios, and other values are sometimes presented in the format of ranges in this specification. It should be understood that such range formats are used for convenience and simplicity and should be flexibly understood as including not only values clearly designated as falling within the range but also all individual values or sub-ranges covered by the range as if each value and sub-range were clearly designated.

In the descriptions of the embodiments and the claims, a list of items preceded by the terms such as “one of”, “one type of”, or other similar terms may mean any one of the listed items. For example, if items A and B are listed, the phrase “one of A and B” means only A or only B. In another example, if items A, B, and C are listed, the phrase “one of A, B, and C” means only A, only B, or only C. The item A may contain a single element or a plurality of elements. The item B may contain a single element or a plurality of elements. The item C may contain a single element or a plurality of elements.

In the descriptions of the embodiments and the claims, a list of items preceded by the terms such as “at least one of”, “at least one type of”, “at least one piece of”, or other similar terms may mean any combination of the listed items. For example, if items A and B are listed, the phrase “one of A and B” means only A, only B, or A and B. In another example, if items A, B, and C are listed, the phrase “at least one of A, B, and C” means only A, or only B, only C, A and B (excluding C), A and C (excluding B), B and C (excluding A), or all of A, B, and C. The item A may contain a single element or a plurality of elements. The item B may contain a single element or a plurality of elements. The item C may contain a single element or a plurality of elements.

### I. Negative Electrode Material

In some embodiments, this application provides a negative electrode material, where the negative electrode material includes silicon-based particles, the silicon-based particles include a silicon-containing matrix and a polymer layer, the polymer layer includes a carbon material and a polymer, and the polymer layer is disposed on at least a portion of a surface of the silicon-containing matrix.

In some embodiments, when a thermogravimetric analysis is conducted at a temperature ranging from 0° C. to 800° C., a derivative thermogravimetric curve of the polymer in a free state has at least one characteristic peak, where a temperature at the maximum characteristic peak of the at least one characteristic peak is T₁, a derivative thermogravimetric curve of the silicon-based particles has at least one characteristic peak, and a temperature at the maximum characteristic peak of the at least one characteristic peak is T₂, and T₁-T₂ is from 1.5° C. to 20° C.

In some embodiments, T₂ is in a temperature range of approximately 150° C. to 600° C. In some embodiments, T₂ is in a temperature range of approximately 200° C. to 450° C. In some embodiments, T₂ is approximately 200° C., approximately 250° C., approximately 300° C., approximately 350° C., approximately 400° C., approximately 450° C., approximately 500° C., approximately 550° C., approximately 600° C., or in a range composed of any two of these values.

In some embodiments, the polymer has a weight-average molecular weight of 1×10⁴ to 2×10⁶. In some embodiments, the polymer has a weight-average molecular weight of approximately 1×10⁴, approximately 10×10⁴, approximately 20×10⁴, approximately 50×10⁴, approximately 80×10⁴, approximately 100×10⁴, approximately 120×10⁴, approximately 150×10⁴, approximately 180×10⁴, approximately 190×10⁴, approximately 200×10⁴, or in a range composed of any two of these values.

In some embodiments, the polymer has a polymer dispersity index (PDI) of approximately 1 to 10. In some embodiments, the polymer has a polymer dispersity index (PDI) of approximately 1, approximately 2, approximately 3, approximately 4, approximately 5, approximately 6, approximately 7, approximately 8, approximately 9, approximately 10, or in a range composed of any two of these values.

In some embodiments, the polymer includes sodium carboxymethyl cellulose, sodium polyacrylate, polyvinyl alcohol, polyamide, polyacrylate, lithium carboxymethyl cellulose (CMC-Li), potassium carboxymethyl cellulose (CMC-K), lithium polyacrylate (PAA-Li), potassium polyacrylate (PAA-K), lithium alginate (ALG-Li), sodium alginate (ALG-Na), potassium alginate (ALG-K), polyacrylonitrile, polyvinylpyrrolidone, polyaniline, polyimide, polyamideimide, polysiloxane, polystyrene-butadiene rubber, epoxy resin, polyester resin, polyurethane resin, polyfluorene, or any combination thereof.

In some embodiments, the silicon-based particles have an average particle size ranging from approximately 500 nm to 30 μm. In some embodiments, the silicon-based particles have an average particle size ranging from approximately 1 μm to 25 μm. In some embodiments, the silicon-based particles have an average particle size of approximately 5 μm, approximately 10 μm, approximately 15 μm, approximately 20 μm, or in a range composed of any two of these values.

In some embodiments, the silicon-containing matrix includes SiOₓ, where 0.6≤x≤1.5.

In some embodiments, the silicon-containing matrix includes Si, SiO, SiO₂, SiC, or any combination thereof.

In some embodiments, the surface of the silicon-containing matrix has a carbon content of less than approximately 5 wt % based on a total weight of the silicon-containing matrix. In some embodiments, the surface of the silicon-containing matrix has a carbon content of approximately 1 wt %, approximately 1.5 wt %, approximately 2.5 wt %, approximately 3 wt %, approximately 4 wt %, approximately 5 wt %, or in a range composed of any two of these values, based on a total weight of the silicon-containing matrix.

In some embodiments, the Si has a particle size of less than approximately 100 nm. In some embodiments, the Si has a particle size of less than approximately 50 nm. In some embodiments, the Si has a particle size of less than approximately 20 nm. In some embodiments, the Si has a particle size of less than approximately 5 nm. In some embodiments, the Si has a particle size of less than approximately 2 nm. In some embodiments, the Si has a particle size of less than approximately 0.5 nm. In some embodiments, the Si has a particle size of approximately 10 nm, approximately 20 nm, approximately 30 nm, approximately 40 nm, approximately 50 nm, approximately 60 nm, approximately 70 nm, approximately 80 nm, approximately 90 nm, or in a range composed of any two of these values.

In some embodiments, the polymer layer has a content of approximately 0.05 wt % to 15 wt %, based on a total weight of the silicon-based particles. In some embodiments, the polymer layer has a content of approximately 1 wt % to 10 wt %, based on a total weight of the silicon-based particles. In some embodiments, the polymer layer has a content of approximately 2 wt %, approximately 3 wt %, approximately 4 wt %, approximately 5 wt %, approximately 6 wt %, approximately 7 wt %, approximately 8 wt %, approximately 9 wt %, approximately 10 wt %, approximately 11 wt %, approximately 12 wt %, approximately 13 wt %, approximately 14 wt %, approximately 15 wt %, or in a range composed of any two of these values, based on a total weight of the silicon-based particles.

In some embodiments, the polymer layer has a thickness of approximately 5 nm to 200 nm. In some embodiments, the polymer layer has a thickness of approximately 10 nm to 150 nm. In some embodiments, the polymer layer has a thickness of approximately 50 nm to 100 nm. In some embodiments, the polymer layer has a thickness of approximately 5 nm, approximately 10 nm, approximately 20 nm, approximately 30 nm, approximately 40 nm, approximately 50 nm, approximately 60 nm, approximately 70 nm, approximately 80 nm, approximately 90 nm, approximately 100 nm, approximately 110 nm, approximately 120 nm, approximately 130 nm, approximately 140 nm, approximately 150 nm, approximately 160 nm, approximately 170 nm, approximately 180 nm, approximately 190 nm, approximately 200 nm, or in a range composed of any two of these values.

In some embodiments, the carbon material includes graphene, carbon nanoparticles, vapor deposited carbon fibers, carbon nanotubes, or any combination thereof. In some embodiments, the carbon nanotubes include single-wall carbon nanotubes, multi-wall carbon nanotubes, or a combination thereof.

In some embodiments, the carbon material has a content of approximately 0.01 wt % to 10 wt %, based on a total weight of the silicon-based particles. In some embodiments, the carbon material has a content of approximately 1 wt % to 8 wt %, based on a total weight of the silicon-based particles. In some embodiments, the carbon material has a content of approximately 0.02 wt %, approximately 0.05 wt %, approximately 0.1 wt %, approximately 0.5 wt %, approximately 1 wt %, approximately 1.5 wt %, approximately 2 wt %, approximately 2.5 wt %, approximately 3 wt %, approximately 4 wt %, approximately 5 wt %, approximately 6 wt %, approximately 7 wt %, approximately 8 wt %, approximately 9 wt %, approximately 10 wt %, or in a range composed of any two of these values, based on a total weight of the silicon-based particles.

In some embodiments, a weight ratio of the polymer in the polymer layer to the carbon material is approximately 1:2 to 10:1. In some embodiments, a weight ratio of the polymer in the polymer layer to the carbon material is approximately 1:2, approximately 1:1, approximately 3:1, approximately 5:1, approximately 7:1, approximately 8:1, approximately 10:1, or in a range composed of any two of these values.

In some embodiments, the carbon nanotube has a diameter of approximately 1 nm to 30 nm. In some embodiments, the carbon nanotube has a diameter of approximately 5 nm to 20 nm. In some embodiments, the carbon nanotube has a diameter of approximately 10 nm, approximately 15 nm, approximately 20 nm, approximately 25 nm, approximately 30 nm, or in a range composed of any two of these values.

In some embodiments, the carbon nanotube has a length-to-diameter ratio of approximately 50 to 30,000. In some embodiments, the carbon nanotube has a length-to-diameter ratio of approximately 100 to 20,000. In some embodiments, the carbon nanotube has a length-to-diameter ratio of approximately 500, approximately 2,000, approximately 5,000, approximately 10,000, approximately 15,000, approximately 20,000, approximately 25,000, approximately 30,000, or in a range composed of any two of these values.

In some embodiments, the silicon-based particle has a specific surface area of approximately 2.5 m²/g to 15 m²/g. In some embodiments, the silicon-based particle has a specific surface area of approximately 5 m²/g to 10 m²/g. In some embodiments, the silicon-based particle has a specific surface area of approximately 3 m²/g, approximately 4 m²/g, approximately 6 m²/g, approximately 8 m²/g, approximately 10 m²/g, approximately 12 m²/g, approximately 14 m²/g, or in a range composed of any two of these values.

In some embodiments, any of the foregoing negative electrode materials further includes graphite particles. In some embodiments, a weight ratio of the graphite particles to the silicon-based particles is approximately 2:1, approximately 3:1, approximately 5:1, approximately 6:1, approximately 7:1, approximately 10:1, approximately 12:1, approximately 15:1, approximately 18:1, approximately 20:1, approximately 50:1, or in a range composed of any two of these values.

### II. Preparation Method of a Negative Electrode Material

An embodiment of this application provides a method for preparing any of the foregoing negative electrode materials, and the method includes:

(1) adding a carbon material to a polymer-containing solution, and dispersing the mixture for approximately 1 h to 24 h to obtain a slurry;

(2) adding a silicon-containing matrix to the above slurry, and dispersing the mixture for approximately 2 h to 10 h to obtain a mixed slurry;

(3) removing the solvent from the mixed slurry; and

(4) performing crushing and sieving on the mixed slurry.

In some embodiments, the method further includes the step of mixing the silicon-based particles and graphite particles.

In some embodiments, the silicon-containing matrix, the carbon material, and the polymer are defined as described above, respectively.

In some embodiments, a weight ratio of the polymer to the carbon material is approximately 1:10 to 10:1. In some embodiments, a weight ratio of the polymer to the carbon material is approximately 1:8, approximately 1:5, approximately 1:3, approximately 1:1, approximately 3:1, approximately 5:1, approximately 7:1, approximately 10:1, or in a range composed of any two of these values.

In some embodiments, a weight ratio of the silicon-containing matrix to the polymer is approximately 200:1 to 10:1. In some embodiments, a weight ratio of the silicon-containing matrix to the polymer is approximately 150:1 to 20:1. In some embodiments, a weight ratio of the silicon-containing matrix to the polymer is approximately 200:1, approximately 150:1, approximately 100:1, approximately 50:1, approximately 10:1, or in a range composed of any two of these values.

In some embodiments, the solvent includes water, ethanol, methanol, n-hexane, N,N-dimethylformamide, pyrrolidone, acetone, toluene, isopropanol, or any combination thereof.

In some embodiments, a dispersion time in step (1) is approximately 1 h, approximately 5 h, approximately 10 h, approximately 15 h, approximately 20 h, approximately 24 h, or a range composed of any two of these values.

In some embodiments, a dispersion time in step (2) is approximately 2 h, approximately 2.5 h, approximately 3 h, approximately 3.5 h, approximately 4 h, approximately 5 h, approximately 6 h, approximately 7 h, approximately 8 h, approximately 9 h, approximately 10 h, or a range composed of any two of these values.

In some embodiments, the method for removing the solvent in step (3) includes rotary evaporation, spray drying, filtration, freeze drying, or any combination thereof.

In some embodiments, the sieving in step (4) is performed through a 400 meshes sieve.

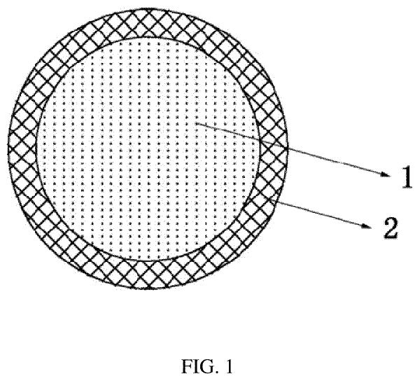

FIG. 1 is a schematic structural diagram of a silicon-based negative active material according to an Example of this application. Where, the inner layer 1 is a silicon-containing matrix, and the outer layer 2 is a polymer layer containing carbon material. The polymer layer containing the carbon material is coated on the surface of the silicon-containing matrix, and the carbon material can be bound on the surface of the silicon-based negative active material by using the polymer, which is beneficial to improve the interface stability of the carbon material on the surface of the negative active material, thereby improving the cycle performance of the negative active material.

Silicon-based negative-electrode materials have a gram capacity of up to 1,500 mAh/g to 4,200 mAh/g, which are considered to be the most promising negative-electrode materials for next-generation lithium-ion batteries. However, due to the low electrical conductivity, and approximately 300% volume expansion and unstable solid electrolyte interface membrane (SEI) during charging and discharging, the further application of silicon is hindered to a certain extent. At present, the following means are mainly used for improving the cycle stability and the rate capability of a silicon-based material: designing a porous silicon-based material, reducing the size of a silica material, and coating with an oxide, a polymer, and a carbon material. Designing porous silicon-based materials and reducing the size of silicon-oxygen materials can improve rate capability to some extent compared to bulk materials, but as cycling proceeds, the occurrence of side reactions and uncontrolled SEI film growth further limit the cycling stability of the materials. The coating of the oxide and the polymer can avoid the contact between an electrolyte solution and the negative electrode material, but the electrochemical resistance is increased due to poor conductivity, and the coating is easily damaged during the process of intercalation and deintercalation of lithium, thereby reducing the cycle life. Among these coating means, the coating of carbon materials can provide excellent conductivity, so it is currently the main application technique. However, during the processing of battery pole pieces, carbon-coated silicon-based materials are likely to be decarburized due to repeated shearing forces, which will affect their Coulomb efficiency; on the other hand, the carbon layer is also easily exfoliated from the matrix due to expansion contraction and cracking of silicon during multiple cycles, with SEI generation and encapsulation of by-product, increasing electrochemical resistance and polarization, thereby affecting cycle life.

The inventor of this application found that there is a weak interaction between the polymer layer and the silicon-containing matrix at the interface, which is more conducive to the uniform coating of the polymer layer on the surface of the silicon-containing matrix. As the polymer layer is uniformly coated on the surface of the silicon-containing matrix, when a thermogravimetric analysis is conducted at a temperature ranging from 0° C. to 800° C., the temperature T₁ at the maximum characteristic peak of the derivative thermogravimetric curve of the polymer in a free state is higher than the temperature T₂ at the maximum characteristic peak of the derivative thermogravimetric curve of the silicon-based particles obtained after the polymer is coated. When the polymer layer is not uniformly distributed on the surface of the silicon-containing matrix, T₁ and T₂ are basically close, and the obtained silicon-based particles with the polymer layer have a poorer cycle effect.

The inventor of this application further found that when T₁-T₂ is in a range of 1.5° C. to 20° C., the lithium-ion battery prepared from the negative active material of this application has improved cycle performance and deformation resistance, as well as reduced DC resistance.

### III. Negative Electrode

An embodiment of this application provides a negative electrode. The negative electrode includes a current collector and a negative active material layer synthesized on the current collector. The negative active material layer includes the negative electrode material according to the embodiments of this application.

In some embodiments, the negative active material layer further includes a binder. In some embodiments, the binder includes, but is not limited to: polyvinyl alcohol, carboxymethyl cellulose, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, Polyvinylidene 1, 1-difluoroethylene, polyethylene, polypropylene, styrene-butadiene rubber, acrylic (ester) styrene-butadiene rubber, epoxy resin, or nylon.

In some embodiments, the negative active material layer further includes a conductive material. In some embodiments, the conductive material includes, but is not limited to: natural graphite, artificial graphite, carbon black, acetylene black, Ketjen black, carbon fiber, metal powder, metal fiber, copper, nickel, aluminum, silver, or a polyphenylene derivative.

In some embodiments, the current collector includes, but is not limited to: copper foil, nickel foil, stainless steel foil, titanium foil, nickel foam, foamy copper, or a polymer substrate coated with a conductive metal.

In some embodiments, the negative electrode may be obtained by using the following method: mixing an active material, a conductive material, and a binder in a solvent to prepare an active material composition, and applying the active material composition on a current collector.

In some embodiments, the solvent includes, but is not limited to N-methylpyrrolidone.

### IV. Positive Electrode

A material, composition, and a manufacturing method of a positive electrode that can be used in the embodiments of this application include any technology disclosed in the prior art. In some embodiments, the positive electrode is the one described in the US patent application U.S. Pat. No. 9,812,739B, which is incorporated in this application by reference in its entirety.

In some embodiments, the positive electrode includes a current collector and a positive active material layer disposed on the current collector.

In some embodiments, the positive active material includes, but is not limited to: lithium cobalt oxide (LiCoO₂), lithium nickel cobalt manganese (NCM) ternary material, lithium ferrous phosphate (LiFePO₄), or lithium manganate (LiMn₂O₄).

In some embodiments, the positive active material layer further includes a binder, and optionally, includes a conductive material. The binder enhances binding between particles of the positive active material, and binding between the positive active material and the current collector.

In some embodiments, the binder includes, but is not limited to: polyvinyl alcohol, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, polyvinylidene 1,1-difluoroethylene, polyethylene, polypropylene, styrene-butadiene rubber, acrylic (ester) styrene-butadiene rubber, epoxy resin, or nylon.

In some embodiments, the conductive material includes, but is not limited to: a carbon-based material, a metal-based material, a conductive polymer, and a mixture thereof. In some embodiments, the carbon-based material is selected from natural graphite, artificial graphite, carbon black, acetylene black, Ketjen black, carbon fiber, or any combination thereof. In some embodiments, the metal-based material is selected from metal powder, metal fiber, copper, nickel, aluminum, or silver. In some embodiments, the conductive polymer is a polyphenylene derivative.

In some embodiments, the current collector includes, but is not limited to aluminum.

The positive electrode may be prepared by using a preparation method known in the art. For example, the positive electrode may be obtained by using the following method: mixing an active material, a conductive material, and a binder in a solvent to prepare an active material composition, and applying the active material composition on a current collector. In some embodiments, the solvent includes, but is not limited to N-methylpyrrolidone.

### V. Electrolyte Solution

The electrolyte solution that can be used in the embodiments of this application may be an electrolyte solution known in the prior art.

In some embodiments, the electrolyte solution includes an organic solvent, a lithium salt, and an additive. The organic solvent of the electrolyte solution according to this application may be any organic solvent known in the prior art that can be used as a solvent of the electrolyte solution. The electrolyte used in the electrolyte solution according to this application is not limited, and it may be any electrolyte known in the prior art. The additive of the electrolyte solution according to this application may be any additive known in the prior art that can be used as an additive of the electrolyte solution.

In some embodiments, the organic solvent includes, but is not limited to: ethylene carbonate (EC), propylene carbonate (PC), diethyl carbonate (DEC), ethyl methyl carbonate (EMC), dimethyl carbonate (DMC), propylene carbonate, or ethyl propionate.

In some embodiments, the lithium salt includes at least one of an organic lithium salt or an inorganic lithium salt.

In some embodiments, the lithium salt includes, but is not limited to: lithium hexafluorophosphate (LiPF₆), lithium tetrafluoroborate (LiBF₄), lithium difluorophosphate (LiPO₂F₂), lithium bistrifluoromethanesulfonimide LiN(CF₃SO₂)₂ (LiTFSI), lithium bis(fluorosulfonyl)imide Li(N(SO₂F)₂) (LiFSI), lithium bisoxalate borate LiB(C₂O₄)₂ (LiBOB), or lithium difluorooxalate borate LiBF₂(C₂O₄) (LiDFOB).

In some embodiments, the lithium salt in the electrolyte solution has a concentration of approximately 0.5 mol/L to 3 mol/L, approximately 0.5 mol/L to 2 mol/L or approximately 0.8 mol/L to 1.5 mol/L.

### VI. Separator

In some embodiments, a separator is disposed between the positive electrode and the negative electrode to prevent short-circuit. The separator used in the embodiments according to this application is not particularly limited to any material or shape, and may be based on any technology disclosed in the prior art. In some embodiments, the separator includes a polymer or an inorganic substance synthesized by a material stable to the electrolyte solution of this application.

For example, the separator may include a substrate layer and a surface finishing layer. The substrate layer is a non-woven fabric, membrane, or composite membrane having a porous structure, and a material of the substrate layer is selected from at least one of polyethylene, polypropylene, polyethylene terephthalate, and polyimide. Specifically, a polypropylene porous membrane, a polyethylene porous membrane, polypropylene nonwoven fabric, polyethylene nonwoven fabric, or polypropylene-polyethylene-polypropylene porous composite membrane may be selected.

The surface finishing layer is provided on at least one surface of the substrate layer, and the surface finishing layer may be a polymer layer or an inorganic layer, or may be a layer formed by a mixed polymer and an inorganic substance.

The inorganic layer includes inorganic particles and a binder. The inorganic particles are selected from one or a combination of aluminum oxide, silicon oxide, magnesium oxide, titanium oxide, hafnium oxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, and barium sulfate. The binder is selected from one or a combination of polyvinylidene fluoride, vinylidene fluoride-hexafluoropropylene copolymer, polyamide, polyacrylonitrile, polyacrylate, polyacrylic acid, polyacrylate, polyvinylpyrrolidone, polyvinyl ether, polymethyl methacrylate, polytetrafluoroethylene, and polyhexafluoropropylene.

The polymer layer includes a polymer, and a material of the polymer is selected from at least one of polyamide, polyacrylonitrile, an acrylate polymer, polyacrylic acid, polyacrylate, polyvinylpyrrolidone, polyvinyl ether, polyvinylidene fluoride, and a poly(vinylidene fluoride-hexafluoropropylene).

### VII. Electrochemical Apparatus

An embodiment of this application provides an electrochemical apparatus, including any device that undergoes an electrochemical reaction.

In some embodiments, the electrochemical apparatus of this application includes: a positive electrode having a positive active material capable of occluding and releasing metal ions; a negative electrode according to an embodiment of this application; an electrolyte solution; and a separator disposed between the positive electrode and the negative electrode.

In some embodiments, the electrochemical apparatus according to this application includes, but is not limited to: all kinds of primary batteries, secondary batteries, fuel cells, solar cells, or capacitors.

In some embodiments, the electrochemical apparatus is a lithium secondary battery.

In some embodiments, the lithium secondary battery includes, but is not limited to: a lithium metal secondary battery, a lithium-ion secondary battery, a lithium polymer secondary battery, or a lithium-ion polymer secondary battery.

### VIII. Electronic Apparatus

The electronic apparatus of this application may be any device that uses the electrochemical apparatus according to the embodiments of this application.

In some embodiments, the electronic apparatus includes, but is not limited to: a notebook computer, a pen-input computer, a mobile computer, an electronic book player, a portable telephone, a portable fax machine, a portable copier, a portable printer, a headset, a video recorder, a liquid crystal television, a portable cleaner, a portable CD player, a mini-disc, a transceiver, an electronic notebook, a calculator, a storage card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, or a lithium ion capacitor.

The following takes a lithium-ion battery as an example and describes preparation of the lithium-ion battery in conjunction with specific Examples. Those skilled in the art will understand that the preparation methods described in this application are merely examples, and any other suitable preparation methods are within the scope of this application.

### EXAMPLES

The following describes performance evaluation according to the Examples and Comparative Examples of the lithium-ion battery of this application.

Test Method

Powder Properties Test Method

1. Specific surface area test: At a constant low temperature, after an adsorption amount of gas on a surface of a solid was measured at different relative pressures, an adsorption amount of a sample monolayer was calculated based on the Brownauer-Etta-Taylor adsorption theory and the formula (BET formula), thereby calculating the specific surface area of the solid.

Approximately 1.5 g to 3.5 g of a powder sample was weighed and put into a TriStar II 3020 test sample tube and degassed at approximately 200° C. for 120 min before testing.

2. Thermogravimetric analysis (TGA) test: A 30 mg to 35 mg sample was accurately weighed and put into an alumina crucible with an opening, a Thermo Gravimetric Analyzer (Thermo Gravimetric Analyze, TGA, equipment model: STA449F3-QMS403C) was used to heat up from 35° C. to 800° C. at a heating rate of 10° C./min, with an N₂ gas purging flow of 60 mL/min and a protective gas flow of 20 mL/min at a heating rate of 10° C./min, so that a curve (namely a thermogravimetric curve) of the sample whose weight changed with a temperature was obtained, and first differentiation was performed on the temperature of the thermogravimetric curve to obtain a derivative thermogravimetric curve.

A material obtained by drying a uniformly mixed slurry obtained in step (1) in the following “Preparation of silicon-based negative active material” at 80° C. for 24 h was defined as a free state of a polymer: thermogravimetric analysis was performed on the material obtained by drying in step 1 and the finally prepared silicon-based negative active material, and a temperature at a maximum characteristic peak of a derivative thermogravimetric curve of the polymer in the free state was recorded as T₁; and a temperature at a maximum characteristic peak of a derivative thermogravimetric curve of the finally prepared silicon-based negative active material was recorded as T₂.

3. Polymer molecular weight test: A specific amount of polymer sample was dissolved in 0.5 moL/L of NaNO₃ and diluted to a concentration of 20 mg/mL, and 30 μL of sample was injected for testing. Gel permeation chromatography (equipped with Waters ACQUITY APC detector) was selected as test equipment, with a column temperature of 40° C., 0.5 mol/L of NaNO₃ solution was selected as a mobile phase solution, with a uniform velocity of 0.4 mL/min, and Waters EmpoWer 3 chromatography management software was used for data acquisition and processing. A polyacrylic acid standard sample of a known different molecular weight was diluted to a concentration of approximately 2 mg/mL, an elution retention time was determined, and a standard curve of a relationship between the molecular weight and the elution retention time was plotted. A weight-average molecular weight Mw and a polymer dispersion index (PDI) of the sample were thus calculated based on the elution retention time of the standard curve.

Button Battery Performance Test

In a dry argon atmosphere, propylene carbonate (PC), ethylene carbonate (EC), and diethyl carbonate (DEC) were mixed (at a weight ratio of approximately 1:1:1) to form a solvent, followed by adding LiPF₆ and mixing uniformly, where LiPF6 had a concentration of approximately 1.15 mol/L, then approximately 7.5 wt % of fluoroethylene carbonate (FEC) was added thereto, and the mixture was mixed uniformly to obtain an electrolyte solution.

The silicon-based negative active materials obtained in Examples and Comparative Examples, conductive carbon black, and a binder PAA (modified polyacrylic acid, PAA) were added into deionized water at a weight ratio of approximately 80:10:10, followed by stirring to form slurry, which was coated by using a scraper to form a coating with a thickness of approximately 100 μm, the coating was dried at approximately 85° C. for 12 h in a vacuum drying oven and cut into wafers with a diameter of approximately 1 cm by using a punching machine in a drying environment, and a button battery was assembled by using a metal lithium sheet as a counter electrode, selecting a ceglard composite film as a separator, and adding an electrolyte solution in a glove box. LAND series battery test was used to conduct charge-discharge test on the battery to test charge and discharge capacities of the battery, where the first coulombic efficiency was a ratio of the charge capacity to the discharge capacity.

Total Battery Performance Test

1. Cycle performance test: At a test temperature of 25° C., the battery was charged to a voltage of 4.45 V at a constant current of 0.7 C, then charged to a current of 0.025 C at a constant voltage, and then discharged to a voltage of 3.0 V at a current of 0.5 C after standing for 5 min. A capacity obtained in this step was an initial capacity, and charge in 0.7 C/discharge in 0.5 C was performed for cycling test, and a capacity attenuation curve was plotted based on a ratio of the capacity of each step to the initial capacity. A quantity of cycles from which the battery was cycled at 25° C. to which the capacity retention ratio was 80% was recorded to compare cycle performance of the batteries.

2. Battery expansion rate test: A thickness of a fresh battery in a half-charging (50% state of charge (SOC)) state was tested by using a spiral micrometer, and a thickness of the battery in a full-charging (100% SOC) state at the moment when the battery was cycled to the capacity attenuated to 80% was tested by using the spiral micrometer and compared with the thickness of the fresh battery in the initial half-charging (50% SOC) state to obtain a expansion rate of the full-charging (100% SOC) battery at the moment.

3. Direct Current Resistance (DCR) test: An actual capacity of a battery cell was tested at 25° C. by using a Maccor machine (charged to 4.4 V at a constant current of 0.7 C, charged to 0.025 C at a constant voltage, standing for 10 min, and discharged to 3.0 V at 0.1 C, standing for 5 min) through 0.1 C discharge at a certain SOC, discharge test was performed for 1 second with a sample collected every 5 ms and a DCR value at 10% SOC was calculated.

II. Preparation of a Lithium-Ion Battery

Preparation of a Positive Electrode

LiCoO₂, conductive carbon black and polyvinylidene fluoride (PVDF) were mixed thoroughly in an N-methylpyrrolidone solvent system at a weight ratio of 96.7:1.7:1.6 to obtain a positive electrode slurry. The prepared positive electrode slurry was coated on the positive current collector aluminum foil, dried, and cold pressed to obtain a positive electrode.

Preparation of a Negative Electrode

Graphite was mixed with the silicon-based negative active material in the Examples and Comparative Examples at a specific ratio to obtain a mixed negative active material with a gram capacity of 450 mAh/g; the mixed negative active material, conductive agent acetylene black, and PAA were mixed and stirred uniformly at a weight ratio of 95:1.2:3.8 in deionized water, and the mixture was coated on Cu foil for drying and cold-pressing to obtain negative plate.

Preparation of an Electrolyte Solution

In a dry argon atmosphere, propylene carbonate (PC), ethylene carbonate (EC), and diethyl carbonate (DEC) were mixed (at a weight ratio of 1:1:1) to form a solvent, followed by adding LiPF₆ and mixing uniformly, where LiPF₆ had a concentration of approximately 1 mol/L, then approximately 10 wt % of fluoroethylene carbonate (FEC) was added thereto, and the mixture was mixed uniformly to obtain an electrolyte solution.

Preparation of a Separator

A PE porous polymer film was used as a separator.

Preparation of a Lithium-Ion Battery

The positive electrode, the separator, and the negative electrode were sequentially stacked, so that the separator was disposed between the positive electrode and negative electrode to play a role of isolation, and winding was performed to obtain a bare cell. The bare cell was put in an outer package, followed by injecting an electrolyte solution and packaging. After technological processes such as chemical conversion, degassing, and trimming, the lithium-ion battery was obtained.

III. Preparation of a Silicon-Based Positive Active Material

1. The silicon-based negative active materials in Examples 1 to 9 and Comparative Examples 1 to 3 were prepared by the following methods:

(1) the carbon material and polymer were dispersed in water at a high speed for 12 h to obtain a uniformly mixed slurry;

(2) SiO (Dv50 was 5.2 μm, and a surface contained 2.5 wt % carbon) was added into the uniformly mixed slurry in step (1), and stirred for 4 h to obtain a uniformly mixed dispersion;

(3) spray drying (inlet temperature of 200° C., outlet temperature of 110° C.) was performed on the dispersion to obtain powder; and

(4) after cooling, the powder sample was taken out, crushed, and sieved through a 400 meshes sieve to obtain silicon-based particles as silicon-based negative active materials.

Table 1 shows types and amounts of various substances used in the preparation methods of the silicon-based negative active materials in Examples 1 to 13 and Comparative Examples 1 to 3.

TABLE 1

| | | | | Weight ratio of silicon-containing |
|---|---|---|---|---|
| | Silicon-containing | | | matrix to carbon material to |
| Serial Number | matrix | Carbon material | Polymer | polymer |
| Example 1 | SiO | SCNT | Sodium carboxymethyl cellulose A | 100:1:1.5 |
| Example 2 | SiO | SCNT | Sodium carboxymethyl cellulose B | 100:1:1.5 |
| Example 3 | SiO | SCNT | Sodium carboxymethyl cellulose C | 100:1:1.5 |
| Example 4 | SiO | SCNT | Sodium polyacrylate | 100:1:1.5 |
| Example 5 | SiO | SCNT | Polyvinyl alcohol (PVA) | 100:1:1.5 |
| Example 6 | SiO | SCNT | Polyacrylate | 100:1:1.5 |
| Example 7 | SiO | SCNT | Polyamide | 100:1:1.5 |
| Example 8 | SiO | SCNT | Sodium carboxymethyl cellulose B | 100:1:2 |
| Example 9 | SiO | SCNT | Sodium carboxymethyl cellulose B | 100:1:2.5 |
| Example 10 | SiO | VGCF | Sodium carboxymethyl cellulose B | 100:1:1.5 |
| Example 11 | SiO | SP | Sodium carboxymethyl cellulose B | 100:1:1.5 |
| Example 12 | SiO | Graphene | Sodium carboxymethyl cellulose B | 100:1:1.5 |
| Example 13 | SiO | MCNT | Sodium carboxymethyl cellulose B | 100:1:1.5 |
| Comparative example 1 | SiO | — | — | — |
| Comparative Example 2 | SiO | SCNT | — | 100:1:0 |
| Comparative example 3 | SiO | — | Sodium carboxymethyl cellulose B | 100:0:1.5 |

“—” indicates that this substance was not added in the preparation process.

Relevant parameters of each substance used in Table 1 were as follows:

Single-walled carbon nanotubes (SCNT): diameter of 1 nm to 5 nm, length-to-diameter ratio of 500 to 30,000;

Single-walled carbon nanotubes (SCNT): diameter of 7 nm to 14 nm, length-to-diameter ratio of 200 to 500;

VGCF: Vapor deposition carbon fiber

SP: Conductive carbon nanoparticles

A weight-average molecular weight Mw of sodium carboxymethyl cellulose A was 69±5K, and a polymer dispersion index (PDI) value was 1.65±0.02;

A weight-average molecular weight Mw of sodium carboxymethyl cellulose

B was 590±10K, and a PDI value was 1.42±0.03;

A weight-average molecular weight Mw of sodium carboxymethyl cellulose C was 950±10K, and a PDI value was 1.35±0.03;

A weight-average molecular weight of sodium polyacrylate was 404±11K, and a PDI value was 3.12±0.1;

A weight-average molecular weight of polyvinyl alcohol (PVA) was 350±20K, and a PDI value was 3.5±0.1;

A weight-average molecular weight of polyacrylate was 454±15K, and a PDI value was 4.12±0.1;

A weight-average molecular weight of polyamide was 603±17K, and a PDI value was 5.12±0.1;

Table 2 shows the relevant performance parameters of the silicon-based negative active materials in Examples 1 to 13 and Comparative Examples 1 to 3

TABLE 2

| | | | | | | | | | Battery | |
|---|---|---|---|---|---|---|---|---|---|---|
| | | | | | | | | Number of | expansion | DCR (room |
| | Specific | Thickness | | | | | | cycles as the | rate as the | temperature, |
| | surface | of polymer | | | | Gram | | capacity | capacity | value under |
| Serial | area | layer | | | T₁ − | capacity | First | attenuated | attenuated | 10% SOC, |
| Number | (m² · g⁻¹) | (nm) | T₁(° C.) | T₂(° C.) | T₂(° C.) | (m² · g⁻¹) | Efficiency | to 80% | to 80% | mΩ) |
| Example 1 | 1.71 | 35 | 275.3 | 263 | 12.3 | 1462 | 64.2% | 812 | 9.5% | 65.3 |
| Example 2 | 1.82 | 38 | 291.9 | 279.4 | 12.5 | 1480 | 64.7% | 840 | 10.2% | 65.2 |
| Example 3 | 1.92 | 42 | 308.2 | 297.7 | 10.5 | 1482 | 64.2% | 801 | 10.4% | 66.2 |
| Example 4 | 2.73 | 42 | 239.4 | 230.8 | 8.6 | 1450 | 64.0% | 825 | 9.8% | 66.5 |
| Example 5 | 2.04 | 45 | 322.5 | 313.3 | 9.2 | 1472 | 63.8% | 790 | 9.9% | 67.2 |
| Example 6 | 1.76 | 32 | 414.3 | 412.6 | 1.7 | 1448 | 64.1% | 782 | 10.3% | 67.3 |
| Example 7 | 1.54 | 30 | 402.4 | 399.9 | 2.5 | 1475 | 64.5% | 784 | 9.7% | 68.2 |
| Example 8 | 1.74 | 50 | 290.8 | 284.3 | 6.5 | 1475 | 64.2% | 790 | 9.6% | 67.7 |
| Example 9 | 1.65 | 72 | 278.2 | 273.5 | 4.5 | 1460 | 63.4% | 785 | 9.8% | 69.2 |
| Example 10 | 1.82 | 32 | 292.5 | 287.6 | 4.9 | 1480 | 64.7% | 754 | 10.8% | 72.0 |
| Example 11 | 1.72 | 33 | 293.4 | 291.8 | 1.6 | 1450 | 63.0% | 740 | 11.0% | 73.5 |
| Example 12 | 2.01 | 42 | 288.9 | 287.5 | 1.4 | 1454 | 63.2% | 762 | 9.7% | 71.3 |
| Example 13 | 1.56 | 35 | 290.5 | 288.2 | 2.3 | 1470 | 63.8% | 750 | 9.9% | 72.0 |
| Comparative | 1.48 | — | — | — | — | 1481 | 64.9% | 710 | 11.2% | 75.8 |
| Example 1 | | | | | | | | | | |
| Comparative | 3.87 | — | — | — | 0.2 | 1475 | 64.2% | 722 | 11.5% | 75.4 |
| Example 2 | | | | | | | | | | |
| Comparative | 1.52 | 30 | 294.3 | 293 | 1.3 | 1465 | 63.2% | 715 | 11.3% | 85.2 |
| Example 3 | | | | | | | | | | |

*The first efficiency was calculated as: Capacity when the charge voltage was 0.8 V/Corresponding capacity when the discharge voltage was 0.005 V.

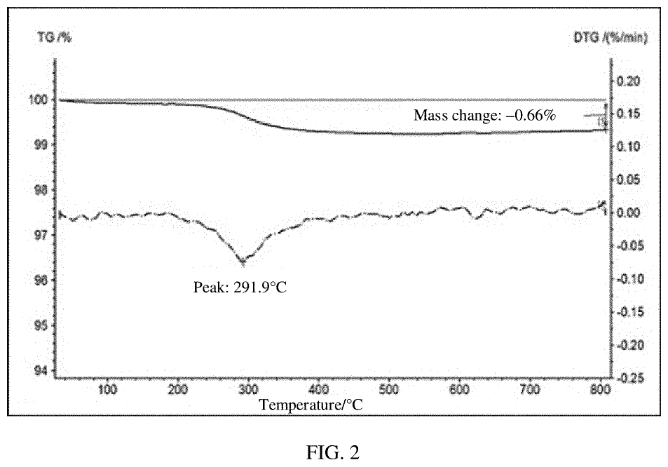

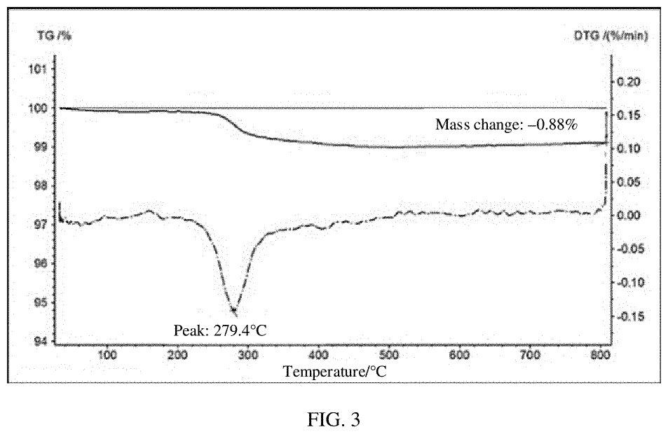

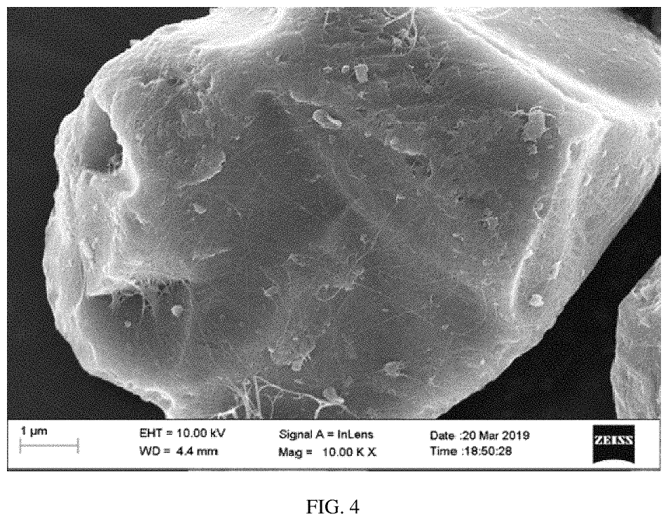

FIG. 2 shows a thermogravimetric curve and a derivative thermogravimetric curve of the polymer in a free state in Example 2 of this application. FIG. 3 shows a thermogravimetric curve and a derivative thermogravimetric curve of the silicon-based negative active material in Example 2 of this application. It could be seen from FIG. 2 and FIG. 3, T₁-T₂ in Example 2 of this application was 12.5° C. FIG. 4 is a scanning electron microscope (SEM) diagram of the silicon-based negative active material in Example 2 of this application. It could be seen from FIG. 4 that there was a composite layer of polymer and carbon nanotubes on the surface of the silicon-based particles.

It could be seen from the test results of Examples 1 to 13 and Comparative Examples 1 to 3, compared with the lithium-ion batteries prepared from the silicon-based negative active materials whose T₁-T₂ was not in the range of 1.5° C. to 20° C., the lithium-ion batteries prepared from the silicon-based negative active materials in the range of 1.5° C. to 20° C. had improved cycle performance and deformation resistance, and reduced DC resistance.

References to “some embodiments”, “an embodiment”, “another example”, “examples”, “specific examples”, or “some examples” in the specification mean the inclusion of specific features, structures, materials, or characteristics described in the embodiment or example in at least one embodiment or example of this application. Accordingly, descriptions appearing in the specification, such as “in some embodiments”, “in the embodiments”, “in an embodiment”, “in another example”, “in an example”, “in a particular example”, or “for example”, are not necessarily references to the same embodiments or examples in this application. In addition, specific features, structures, materials, or characteristics herein may be incorporated in any suitable manner into one or more embodiments or examples.

Although illustrative embodiments have been demonstrated and described, those skilled in the art should understand that the foregoing embodiments are not to be construed as limiting this application, and that the embodiments may be changed, replaced, and modified without departing from the spirit, principle, and scope of this application.

What is claimed is:

1. A negative electrode material, comprising: silicon-based particles, wherein the silicon-based particles comprise a silicon-containing matrix and a polymer layer disposed on at least a portion of a surface of the silicon-containing matrix, and the polymer layer comprises a carbon material and a polymer;
when a thermogravimetric analysis is conducted at a temperature ranging from 0° C. to 800° C.:
a derivative thermogravimetric curve of the polymer in a free state has at least one characteristic peak, and a temperature at the maximum characteristic peak of the at least one characteristic peak is T₁, and
a derivative thermogravimetric curve of the silicon-based particles has at least one characteristic peak, and a temperature at the maximum characteristic peak of the at least one characteristic peak is T₂, and T₁-T₂ is from 1.5° C. to 20° C.

2. The negative electrode material according to claim 1, wherein T₂ is in a temperature range of 150° C. to 600° C.

3. The negative electrode material according to claim 1, wherein T₂ is in a temperature range of 200° C. to 450° C.

4. The negative electrode material according to claim 1, wherein the polymer has a weight-average molecular weight of 1×10⁴ to 2×10⁶.

5. The negative electrode material according to claim 1, wherein the polymer comprises sodium carboxymethyl cellulose, sodium polyacrylate, polyvinyl alcohol, polyamide, polyacrylate, lithium carboxymethyl cellulose, potassium carboxymethyl cellulose, lithium polyacrylate, potassium polyacrylate, lithium alginate, sodium alginate, potassium alginate, polyacrylonitrile, polyvinylpyrrolidone, polyaniline, polyimide, polyamideimide, polysiloxane, polystyrene-butadiene rubber, epoxy resin, polyester resin, polyurethane resin, polyfluorene, or any combination thereof.

6. The negative electrode material according to claim 1, wherein the silicon-containing matrix comprises SiOₓ, and 0.6≤x≤1.5.

7. The negative electrode material according to claim 1, wherein the silicon-containing matrix comprises Si, SiO, SiO₂, SiC, or any combination thereof.

8. The negative electrode material according to claim 1, wherein the surface of the silicon-containing matrix contains less than 5 wt % of carbon based on a total weight of the silicon-containing matrix.

9. The negative electrode material according to claim 1, wherein based on a total weight of the silicon-based particles, the polymer layer has content ranging from 0.05 wt % to 15 wt %; the carbon material has content ranging from 0.01 wt % to 10 wt %; and/or a weight ratio of the polymer to the carbon material is 1:2 to 10:1.

10. The negative electrode material according to claim 1, wherein the carbon material comprises graphene, carbon nanoparticles, vapor deposited carbon fibers, carbon nanotubes, or any combination thereof.

11. The negative electrode material according to claim 10, wherein the carbon material comprises carbon nanotubes; the carbon nanotubes have a diameter ranging from 1 nm to 30 nm, and the carbon nanotubes have a length-to-diameter ratio ranging from 50 to 30,000.

12. The negative electrode material according to claim 1, wherein the polymer layer has a thickness ranging from 5 nm to 200 nm.

13. The negative electrode material according to claim 1, wherein the silicon-based particles have an average particle size ranging from 500 nm to 30 μm.

14. The negative electrode material according to claim 1, wherein the silicon-based particles have a specific surface area ranging from 1 m²/g to 50 m²/g.

15. A negative electrode, comprising: a negative electrode material, the negative electrode material comprises silicon-based particles, wherein the silicon-based particles comprise a silicon-containing matrix and a polymer layer disposed on at least a portion of a surface of the silicon-containing matrix, and the polymer layer comprises a carbon material and a polymer;
when a thermogravimetric analysis is conducted at a temperature ranging from 0° C. to 800° C.:
a derivative thermogravimetric curve of the polymer in a free state has at least one characteristic peak, and a temperature at the maximum characteristic peak of the at least one characteristic peak is T₁, and
a derivative thermogravimetric curve of the silicon-based particles has at least one characteristic peak, and a temperature at the maximum characteristic peak of the at least one characteristic peak is T₂, and T₁-T₂ is from 1.5° C. to 20° C.

16. An electrochemical apparatus, comprising the negative electrode according to claim 15.

17. An electronic apparatus, comprising the electrochemical apparatus according to claim 16.
